(19) United States
(12) Patent Application Publication
(10) Pub. No.: US 2020/0065700 A1
(43) Pub. Date: Feb. 27, 2020

(54) Data Processing Method, Apparatus and Readable Storage Medium for Evaluating Ride Comfortability

(71) Applicant: Baidu Online Network Technology (Beijing) Co., Ltd., Beijing (CN)

(72) Inventors: Rui LIU, Beijing (CN); Yaling ZHANG, Beijing (CN); Yunyan HU, Beijing (CN); Ji TAO, Beijing (CN); Ruixiang SHEN, Beijing (CN)

(73) Assignee: Baidu Online Network Technology (Beijing) Co., Ltd., Beijing (CN)

(21) Appl. No.: 16/507,458

(22) Filed: Jul. 10, 2019

(30) Foreign Application Priority Data
Aug. 27, 2018 (CN) 201810983689.2

(51) Int. Cl. G06N 20/00

(52) U.S. Cl. CPC G06N 20/00; B60W 2550/12; B60W 2550/14; B60W 2520/10; B60W 2520/105; B60W 50/0098; B60W 2510/20; B60W 2520/16; B60W 2520/18; B60W 2540/22; B60W 2510/18

(57) ABSTRACT

The disclosure provides a data processing method, apparatus and readable storage medium for evaluating ride comfortability, by receiving evaluation data input by a user through a data collection port, the evaluation data includes evaluation information of the user for each driving action of a vehicle on which the user rides, determining environmental information and/or vehicle driving parameters when the vehicle executes each driving action, according to the evaluation information corresponding to each driving action of the vehicle, as well as the environmental information and/or vehicle driving parameters, training a preset deep learning algorithm model, to obtain an evaluation model for outputting ride comfortability, the data processing flow for ride comfortability is simplified by establishing an evaluation model that can be configured to output ride comfortability, the processing efficiency is improved; it also makes the evaluation of the obtained ride comfortability more objective, with higher universality.

### CROSS-REFERENCE TO RELATED APPLICATION

This application claims priority to Chinese Patent Application No. 201810983689.2, filed on Aug. 27, 2018, which is hereby incorporated by reference in its entirety.

### TECHNICAL FIELD

The present disclosure relates to an autonomous driving technology, and in particular to a data processing method, an apparatus and a readable storage medium for evaluating ride comfortability.

### BACKGROUND

With the development of science and technology and the advancement of society, the autonomous driving technology has become a development trend in the field of transportation. In order to provide passengers with a better ride experience, the evaluation of ride comfortability during the autonomous driving is also an essential part.

In the prior art, the data processing for evaluating the ride comfortability is generally realized manually, that is, by collecting the ride experience information recorded by the test passengers, manually conducts statistical analysis of a large number of ride experience information to obtain the ride comfortability of the vehicle.

However, in this way, the data processing procedure of the ride comfortability is cumbersome, the processing efficiency is not high, and the subjectiveness of the evaluation of the ride comfortability is strong, and the evaluated result has low universality.

### SUMMARY

In view of the above-mentioned problems in the existing data processing for evaluating ride comfortability, such as, the cumbersome data processing flow caused by the manual method, the low processing efficiency, the high subjectiveness of the obtained ride comfortability, and the low universality of the evaluated result, the present disclosure provides a data processing method, an apparatus and a readable storage medium for evaluating ride comfortability.

In a first aspect, the present disclosure provides a data processing method for evaluating ride comfortability, including:

receiving evaluation data input by a user through a data collection port, the evaluation data comprising evaluation information of the user for each driving action of a vehicle on which the user rides;

determining environmental information and/or vehicle driving parameters when the vehicle executes each driving action;

according to the evaluation information corresponding to each driving action of the vehicle, as well as the environmental information and/or vehicle driving parameters, training a preset deep learning algorithm model, to obtain an evaluation model for outputting ride comfortability.

In an alternative embodiment, the evaluation information includes one or more of the following information:

feeling of pushing a back, centrifugal feeling, bumpy feeling, forward feeling, frustration feeling and swaying feeling.

In an alternative embodiment, the determining environmental information and/or vehicle driving parameters when the vehicle executes each driving action, including:

determining an execution location and an execution time when the vehicle executes each driving action;

determining the environmental information and/or vehicle driving parameters according to the execution location and the execution time.

In an alternative embodiment, the environmental information includes one or more of the following information:

weather information, road condition information and road surface status information;

and/or, the vehicle driving parameters include one or more of the following information:

vehicle model, driving speed, vehicle acceleration, rate of acceleration change, throttle output, brake output, turning angle, front and rear tilting angle, left and right swinging angle.

In a second aspect, a data processing method for evaluating ride comfortability, wherein, including:

obtaining a driving action to be evaluated, and determining environmental information and/or vehicle driving parameters corresponding to the driving action to be evaluated;

inputting the environmental information and/or vehicle driving parameters corresponding to the driving action to be evaluated into the evaluation model constructed by the method according to any of the preceding methods, and outputting the ride comfortability corresponding to the driving action to be evaluated.

In an alternative embodiment, the evaluation information includes one or more of the following information:

feeling of pushing a back, centrifugal feeling, bumpy feeling, forward feeling, frustration feeling and swaying feeling.

In an alternative embodiment, the environmental information includes one or more of the following information:

weather information, road condition information and road surface status information;

and/or, the vehicle driving parameters include one or more of the following information:

vehicle model, driving speed, vehicle acceleration, rate of acceleration change, throttle output, brake output, turning angle, front and rear tilting angle, left and right swinging angle.

In a third aspect, the present disclosure provides a data processing apparatus for evaluating ride comfortability, including:

an evaluation information collection module, configured to receive evaluation data input by a user through a data collection port, the evaluation data including evaluation information of the user for each driving action of a vehicle on which the user rides;

a processing module, configured to determine environmental information and/or vehicle driving parameters when the vehicle executes each driving action;

a training module, configured to, according to the evaluation information corresponding to each driving action of the vehicle, as well as the environmental information and/or vehicle driving parameters, train a preset deep learning algorithm model, to obtain an evaluation model for outputting ride comfortability.

In an alternative embodiment, the evaluation information includes one or more of the following information:

feeling of pushing a back, centrifugal feeling, bumpy feeling, forward feeling, frustration feeling and swaying feeling.

In an alternative embodiment, the processing module is specifically configured to:

determine an execution location and an execution time when the vehicle executes each driving action;

determine the environmental information and/or vehicle driving parameters according to the execution location and the execution time.

In an alternative embodiment, the environmental information includes one or more of the following information:

weather information, road condition information and road surface status information;

and/or, the vehicle driving parameters include one or more of the following information:

vehicle model, driving speed, vehicle acceleration, rate of acceleration change, throttle output, brake output, turning angle, front and rear tilting angle, left and right swinging angle.

In a fourth aspect, the present disclosure provides a data processing apparatus for evaluating ride comfortability, including:

a data collection module, configured to obtain a driving action to be evaluated, and determine environmental information and/or vehicle driving parameters corresponding to the driving action to be evaluated;

an identification module, configured to input the environmental information and/or vehicle driving parameters corresponding to the driving action to be evaluated into the evaluation model constructed by the method according to any of the preceding methods, and output the ride comfortability corresponding to the driving action to be evaluated.

In an alternative embodiment, the evaluation information includes one or more of the following information:

feeling of pushing a back, centrifugal feeling, bumpy feeling, forward feeling, frustration feeling and swaying feeling.

In an alternative embodiment, the environmental information includes one or more of the following information:

weather information, road condition information and road surface status information;

and/or, the vehicle driving parameters include one or more of the following information:

vehicle model, driving speed, vehicle acceleration, rate of acceleration change, throttle output, brake output, turning angle, front and rear tilting angle, left and right swinging angle.

In the fifth aspect, the disclosure provides a data processing apparatus for evaluating ride comfortability, including: a memory, a processor coupled to the memory, and a computer program stored on the memory and executable on the processor, wherein,

the processor performs any one of the above methods when executing the computer program.

In the sixth aspect, the disclosure provides a data processing apparatus for evaluating ride comfortability, including: a memory, a processor coupled to the memory, and a computer program stored on the memory and executable on the processor, wherein,

the processor performs any one of the above methods when executing the computer program.

In the seventh aspect, the disclosure provides a readable storage medium, wherein, including a program, when executed on a terminal, causing the terminal to execute the method as described in any of the preceding aspects.

In the eighth aspect, the disclosure provides a readable storage medium, wherein, comprising a program, when executed on a terminal, causing the terminal to perform any one of the above methods.

The data processing method, apparatus and readable storage medium for evaluating ride comfortability provided by the present disclosure, by receiving evaluation data input by a user through a data collection port, the evaluation data including evaluation information of the user for each driving action of a vehicle on which the user rides, determining environmental information and/or vehicle driving parameters when the vehicle executes each driving action, according to the evaluation information corresponding to each driving action of the vehicle, as well as the environmental information and/or vehicle driving parameters, training a preset deep learning algorithm model, to obtain an evaluation model for outputting ride comfortability, the data processing flow for ride comfortability is simplified by establishing an evaluation model that can be used to output ride comfortability, the processing efficiency is improved; at the same time, the evaluation model takes into account the environmental information and/or vehicle driving parameters, making the evaluation of the ride comfortability more objective, the evaluation model can be adapted to the evaluation of vehicles of various types and various test ride environments, with higher universality.

### BRIEF DESCRIPTION OF THE DRAWINGS

Through the above drawings, explicit embodiments of the present disclosure have been shown, which will be described in more detail later. The drawings and the description are not intended to limit the scope of the present disclosure in any way, but the concepts of the present disclosure will be described to those skilled in the art by reference to the specific embodiments.

FIG. 1 is a schematic diagram of a network architecture based on the present disclosure;

FIG. 2 is a schematic flowchart of a data processing method for evaluating ride comfortability according to Embodiment 1 of the present disclosure;

FIG. 3 is a schematic flowchart of a data processing method for evaluating ride comfortability according to Embodiment 2 of the present disclosure;

FIG. 4 is a schematic structural diagram of a data processing apparatus for evaluating ride comfortability according to Embodiment 3 of the present disclosure;

FIG. 5 is a hardware schematic diagram of a data processing apparatus for evaluating ride comfortability according to the present disclosure;

FIG. 6 is an another hardware schematic diagram of a data processing apparatus for evaluating ride comfortability provided by the present disclosure.

The drawings herein are incorporated in and constitute a part of the specification, show embodiments conforming to the present disclosure and are used with the specification to explain the principles of the present disclosure.

### DETAILED DESCRIPTION OF THE EMBODIMENTS

In order to make the objectives, technical solutions, and advantages of embodiments of the present disclosure more clearly, the technical solutions in the embodiments of the present disclosure are described clearly and completely in conjunction with the accompanying drawings in the embodiments of the present disclosure.

With the development of science and technology and the advancement of society, the autonomous driving technology has become a development trend in the field of transportation. In order to provide passengers with a better ride experience, the evaluation of ride comfortability during autonomous driving is also an essential part.

In the prior art, the data processing for evaluating the ride comfortability is generally realized manually, that is, by collecting the ride experience information recorded by the test passengers, manually conducts statistical analysis of a large number of ride experience information to obtain the ride comfortability of the vehicle.

However, in this way, the data processing procedure of the ride comfortability is cumbersome, the processing efficiency is not high, and the subjectiveness of the evaluation of the ride comfortability is strong, and the evaluated result has low universality.

In response to the above mentioned technical problems, the present disclosure provides a data processing method, an apparatus and a readable storage medium for evaluating ride comfortability. It should be noted that the data processing method, apparatus and readable storage medium for evaluating ride comfortability provided by the present application can be applied in application scenarios that are widely required to evaluate the ride comfortability, including but not limited to: vehicle performance evaluation of new cars, performance evaluation of autonomous driving programs, etc.

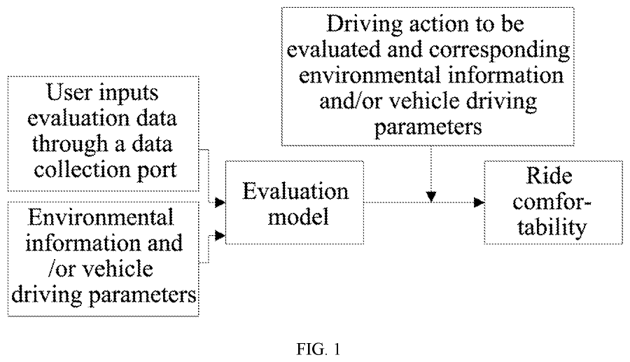

FIG. 1 is a schematic diagram of a network architecture based on the present disclosure, as shown in FIG. 1, unlike the prior art, in the present application, the user can log in a data collection port by using a terminal to input evaluation data to the data processing apparatus for evaluating the ride comfortability, so that he/she can obtain environmental information and/or vehicle driving parameters corresponding to the evaluation data from the network server side, and obtain an evaluation model for outputting the ride comfortability.

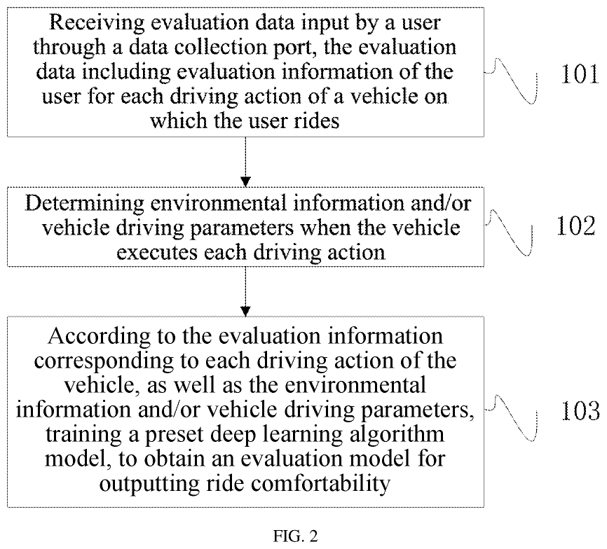

FIG. 2 is a schematic flowchart of a data processing method for evaluating ride comfortability according to Embodiment 1 of the present disclosure.

As shown in FIG. 2, the data processing method includes:

Step 101, receiving evaluation data input by a user through a data collection port, the evaluation data including evaluation information of the user for each driving action of a vehicle on which the user rides.

Step 102, determining environmental information and/or vehicle driving parameters when the vehicle executes each driving action.

Step 103, according to the evaluation information corresponding to each driving action of the vehicle, as well as the environmental information and/or vehicle driving parameters, training a preset deep learning algorithm model, to obtain an evaluation model for outputting ride comfortability.

It should be noted, the execution body of the data processing method for evaluating ride comfortability provided by the present disclosure may specifically be a data processing apparatus for evaluating ride comfortability, the data processing apparatus can execute an data interaction with the data collection port that the user logs in, and can also perform communication and data interaction with a network server.

Specifically, the present disclosure provides a data processing method for evaluating ride comfortability, first, a data processing apparatus for evaluating ride comfortability receives evaluation data input by a user through a data collection port, the evaluation data including evaluation information of the user for each driving action of a vehicle on which the user rides. Further, when testing riding the vehicle, the user can log in to the data collection application through the terminal, and upload the evaluation data input during the test ride through the data collection port provided by the data collection application. In general, the evaluation is performed based on the test ride tasks, and the test ride tasks include various driving actions executed by the vehicle during the automatic driving process, such as starting, braking, steering, acceleration, parking, and the like. The evaluation data correspond to the test ride tasks, which may include evaluation information evaluated by the user on each driving action executed by the vehicle. The evaluation information may be in the form of a scoring measurement, or other measurement forms, and the application does not limit this.

Optional, in other embodiments, the evaluation information includes one or more of the following information: feeling of pushing a back, centrifugal feeling, bumpy feeling, forward feeling, frustration feeling and swaying feeling. Specifically, the feeling of pushing a back means a feeling that the back of a chair is pressed against the back to push him/her forward; the centrifugal feeling means that people have a feeling of being pressed or pulled out in one direction in the lateral direction; the bumpy feeling means that people have a feeling of leaving the seat in the air with a certain weight loss; the forward feeling means that means that people have a feeling of leaning forward or with a certain degree of nodding; the frustration feeling means that people have a feeling that the driving is not smooth or carsickness; the swaying feeling means that people feel that the driving strategy of the vehicle is unsafe and unreliable, and the behavior trajectory is erratic. By setting at least one of the above dimensions of evaluation information, the evaluation model can output more comprehensive evaluation information.

Subsequently, the data processing apparatus for evaluating ride comfortability determines environmental information and/or vehicle driving parameters when the vehicle executes each driving action. Specifically, in order to evaluate the ride comfortability, it is necessary to establish a relationship between the driving action and the evaluation information. In order to make the evaluation information that the evaluation model can output more objective and more universal, in this application, the environmental information and/or vehicle driving parameters of the vehicle when performing the driving action also need to be determined.

Optional, the environmental information includes one or more of the following information: weather information, road condition information and road surface status information. Wherein, the weather information refers to the weather when the driving action is performed, such as rainy days, snowy days, sunny days, windy, etc.; the road condition information refers to the traffic conditions on the road when the driving action is executed, such as smooth, slight traffic jam, severe congestion, etc.; the road surface status information refers to the type of road surface when the driving action is executed, such as asphalt road, grass, dirt road, etc.

The vehicle driving parameters include one or more of the following information: vehicle model, driving speed, vehicle acceleration, rate of acceleration change, throttle output, brake output, turning angle, front and rear tilting angle, left and right swinging angle. Wherein, the vehicle model refers to the brand, model, type of vehicle, etc. of the vehicle that executes the driving action; the above driving speed, turning angle, front and rear tilting angle, and left and right swinging angle are vehicle driving parameters that can all be measured by a vehicle sensor.

At last, according to the evaluation information corresponding to each driving action of the vehicle, as well as environmental information and/or vehicle driving parameters, a preset deep learning algorithm model is trained, to obtain an evaluation model for outputting ride comfortability. Specifically, using the collected evaluation information, and environmental information and/or vehicle driving parameters, the deep learning algorithm model is trained in combination with driving action, so that the corresponding ride comfortability is output according to the input driving action, as well as the environmental information and/or the vehicle driving parameters.

The data processing method for evaluating ride comfortability provided by Embodiment 1 of the present disclosure, by receiving evaluation data input by a user through a data collection port, the evaluation data including evaluation information of the user for each driving action of the vehicle on which the user rides, the environmental information and/or vehicle driving parameters when the vehicle executes each driving action is determined, according to the evaluation information corresponding to each driving action of the vehicle, as well as the environmental information and/or vehicle driving parameters, a preset deep learning algorithm model is trained, to obtain an evaluation model for outputting ride comfortability. By establishing the evaluation model that can be used to output ride comfortability, the data processing flow for ride comfortability is simplified, and the processing efficiency is improved; at the same time, the evaluation model takes into account environmental information and/or vehicle driving parameters, making the evaluation of the ride comfortability more objective, and the evaluation model can be adapted to the evaluation of vehicles of various types and various test ride environments, with higher universality.

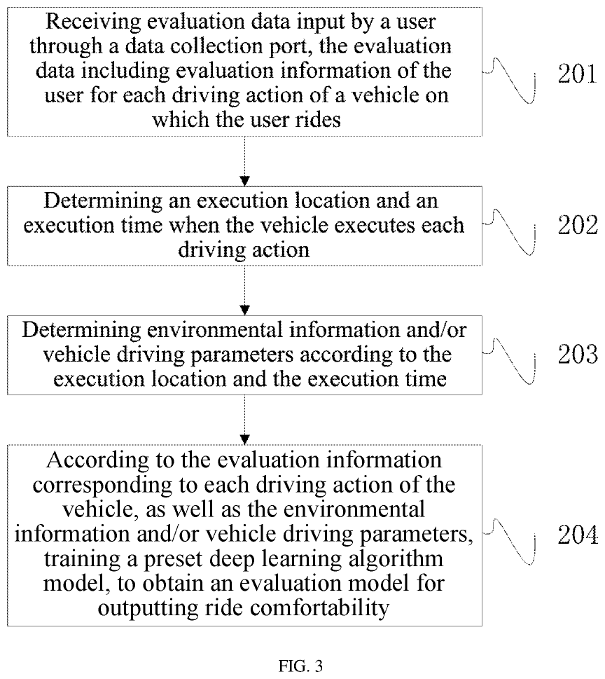

FIG. 3 is a schematic flowchart of a data processing method for evaluating ride comfortability according to Embodiment 2 of the present disclosure.

As shown in FIG. 3, the data processing method includes:

Step 201, receiving evaluation data input by a user through a data collection port, the evaluation data including evaluation information of the user for each driving action of a vehicle on which the user rides.

Step 202, determining an execution location and an execution time when the vehicle executes each driving action.

Step 203, determining environmental information and/or vehicle driving parameters according to the execution location and the execution time.

Step 204, according to the evaluation information corresponding to each driving action of the vehicle, as well as the environmental information and/or vehicle driving parameters, training a preset deep learning algorithm model, to obtain an evaluation model for outputting ride comfortability.

It should be noted, the execution body of the data processing method for evaluating ride comfortability provided by the present disclosure may specifically be a data processing apparatus for evaluating ride comfortability, the data processing apparatus can execute an data interaction with the data collection port that the user logs in, and can also perform communication and data interaction with the network server.

Specifically, similar to Embodiment 1, Embodiment 2 provides a data processing method for evaluating ride comfortability, first, a data processing apparatus for evaluating ride comfortability receives evaluation data input by a user through a data collection port, the evaluation data including evaluation information of the user for each driving action of a vehicle on which the user rides. Further, when testing riding the vehicle, the user can log in to the data collection application through the terminal, and upload the evaluation data input during the test ride through the data collection port provided by the data collection application. In general, the evaluation is performed based on the test ride tasks, and the test ride tasks include various driving actions executed by the vehicle during the automatic driving process, such as starting, braking, steering, acceleration, parking, and the like. The evaluation data correspond to the test ride tasks, which may include evaluation information evaluated by the user on each driving action executed by the vehicle. The evaluation information may be in the form of a scoring measurement, or other measurement forms, and the application does not limit this.

Optional, in other embodiments, the evaluation information includes one or more of the following information: feeling of pushing a back, centrifugal feeling, bumpy feeling, forward feeling, frustration feeling and swaying feeling. Specifically, the feeling of pushing a back means a feeling that the back of a chair is pressed against the back to push him/her forward; the centrifugal feeling means that people have a feeling of being pressed or pulled out in one direction in the lateral direction; the bumpy feeling means that people have a feeling of leaving the seat in the air with a certain weight loss; the forward feeling means that means that people have a feeling of leaning forward or with a certain degree of nodding; the frustration feeling means that people have a feeling that the driving is not smooth or carsickness; the swaying feeling means that people feel that the driving strategy of the vehicle is unsafe and unreliable, and the behavior trajectory is erratic. By setting at least one of the above dimensions of evaluation information, the evaluation model can output more comprehensive evaluation information.

Subsequently, different from the Embodiment 1, the data processing apparatus for evaluating ride comfortability determining environmental information and/or vehicle driving parameters when the vehicle executes each driving action, specifically, includes: determining an execution location and an execution time when the vehicle executes each driving action; and determining the environmental information and/or vehicle driving parameters according to the execution location and the execution time. Wherein, when the vehicle executes each driving action, the data processing apparatus also records the execution location and execution time when the driving action is executed, while receiving the evaluation information, the environmental parameters at each execution time of each execution location can then be obtained through a web server, and the vehicle driving parameters of the vehicle at each execution time of each execution location can also be obtained.

Optional, the environmental information includes one or more of the following information: weather information, road condition information and road surface status information. Wherein, the weather information refers to the weather when the driving action is executed, such as rainy days, snowy days, sunny days, windy, etc.; the road condition information refers to the traffic conditions on the road when the driving action is executed, such as smooth, slight traffic jam, severe congestion, etc.; the road surface status information refers to the type of road surface when the driving action is executed, such as asphalt road, grass, dirt road, etc. The vehicle driving parameters include one or more of the following information: vehicle model, driving speed, turning angle, front and rear tilting angle, left and right swinging angle, vehicle acceleration, rate of acceleration change, throttle output, brake output. Wherein, the vehicle model refers to the brand, model, type of vehicle, etc. of the vehicle that executes the driving action; the above driving speed, turning angle, front and rear tilting angle, left and right swinging angle, vehicle acceleration, rate of acceleration change, throttle output, and brake output, etc. are vehicle driving parameters that can all be measured by a vehicle sensor.

At last, according to the evaluation information corresponding to each driving action of the vehicle, as well as environmental information and/or vehicle driving parameters, a preset deep learning algorithm model is trained, to obtain an evaluation model for outputting ride comfortability. Specifically, using the collected evaluation information, and the environmental information and/or vehicle driving parameters, the deep learning algorithm model is trained in combination with driving action, so that it can output the corresponding ride comfortability according to the input driving action, as well as the environmental information and/or the vehicle driving parameters.

The data processing method for evaluating ride comfortability provided by Embodiment 2 of the present disclosure, by receiving evaluation data input by a user through a data collection port, the evaluation data including evaluation information of the user for each driving action of the vehicle on which the user rides, the environmental information and/or vehicle driving parameters when the vehicle executes each driving action is determined, according to the evaluation information corresponding to each driving action of the vehicle, as well as the environmental information and/or vehicle driving parameters, a preset deep learning algorithm model is trained, to obtain an evaluation model for outputting ride comfortability. By establishing the evaluation model that can be used to output ride comfortability, the data processing flow for ride comfortability is simplified, and the processing efficiency is improved; at the same time, the evaluation model takes into account environmental information and/or vehicle driving parameters, making the evaluation of the ride comfortability more objective, and the evaluation model can be adapted to the evaluation of vehicles of various types and various test ride environments, with higher universality.

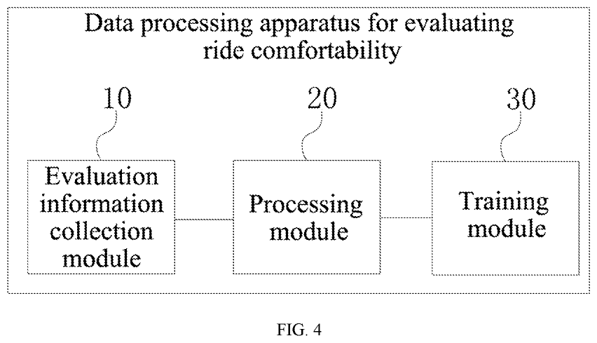

FIG. 4 is a schematic structural diagram of a data processing apparatus for evaluating ride comfortability according to Embodiment 3 of the present disclosure, as shown in FIG. 4, the data processing apparatus for evaluating ride comfortability includes:

an evaluation information collection module 10 configured to receive evaluation data input by a user through a data collection port, the evaluation data including evaluation information of the user for each driving action of a vehicle on which the user rides;

a processing module 20 configured to determine environmental information and/or vehicle driving parameters when the vehicle executes each driving action;

a training module 30, configured to, according to the evaluation information corresponding to each driving action of the vehicle, as well as the environmental information and/or vehicle driving parameters, train a preset deep learning algorithm model, to obtain an evaluation model for outputting ride comfortability.

Optional, the evaluation information includes one or more of the following information:

feeling of pushing a back, centrifugal feeling, bumpy feeling, forward feeling, frustration feeling and swaying feeling.

Optional, the processing module 20 is configured to:

determine an execution location and an execution time when the vehicle executes each driving action;

determine the environmental information and/or vehicle driving parameters according to the execution location and the execution time.

Optional, the environmental information includes one or more of the following information:

weather information, road condition information and road surface status information;

and/or, the vehicle driving parameters include one or more of the following information:

vehicle model, driving speed, vehicle acceleration, rate of acceleration change, throttle output, brake output, turning angle, front and rear tilting angle, left and right swinging angle.

A person skilled in the art can clearly understand that for the convenience and brevity of the description, the specific working process of the system described above and the corresponding beneficial effects can refer to the corresponding processes in the foregoing method embodiments, and details are not described herein again.

The data processing apparatus for evaluating ride comfortability provided by the present disclosure, by receiving evaluation data input by a user through a data collection port, the evaluation data including evaluation information of the user for each driving action of the vehicle on which the user rides, the environmental information and/or vehicle driving parameters when the vehicle executes each driving action is determined, according to the evaluation information corresponding to each driving action of the vehicle, as well as the environmental information and/or vehicle driving parameters, a preset deep learning algorithm model is trained, to obtain an evaluation model for outputting ride comfortability. By establishing the evaluation model that can be used to output ride comfortability, the data processing flow for ride comfortability is simplified, and the processing efficiency is improved; at the same time, the evaluation model takes into account environmental information and/or vehicle driving parameters, making the evaluation of the ride comfortability more objective, and the evaluation model can be adapted to the evaluation of vehicles of various types and various test ride environments, with higher universality.

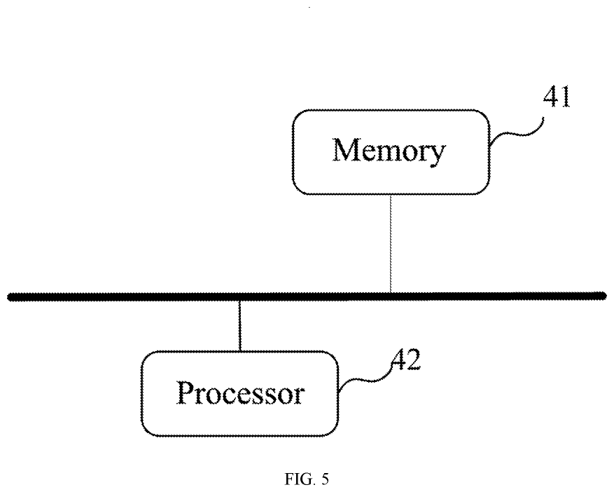

FIG. 5 is a hardware schematic diagram of a data processing apparatus for evaluating ride comfortability provided by the present disclosure. As shown in FIG. 5, the terminal includes a processor 42 and a computer program stored on a memory 41 and operable on the processor 42, the processor 42 performs the method of any of the above embodiments when executing the computer program.

Embodiment 5 of the present disclosure also provides a data processing method for evaluating ride comfortability, specifically, it may include: obtaining a driving action to be evaluated, and determining environmental information and/or vehicle driving parameters corresponding to the driving action to be evaluated; inputting the environmental information and/or vehicle driving parameters corresponding to the driving action to be evaluated into an evaluation model constructed by the method described in Embodiment 1 or Embodiment 2, and outputting the ride comfortability corresponding to the driving action to be evaluated.

In an alternative embodiment, the evaluation information includes one or more of the following information: feeling of pushing a back, centrifugal feeling, bumpy feeling, forward feeling, frustration feeling and swaying feeling.

In an alternative embodiment, the environmental information includes one or more of the following information: weather information, road condition information and road surface status information; and/or, the vehicle driving parameters include one or more of the following information: vehicle model, driving speed, vehicle acceleration, rate of acceleration change, throttle output, brake output, turning angle, front and rear tilting angle, left and right swinging angle.

A person skilled in the art can clearly understand that for the convenience and brevity of the description, the specific working process of the system described above and the corresponding beneficial effects can refer to the corresponding processes in the foregoing method embodiments, and details are not described herein again.

Embodiment 6 of the present disclosure also provides a data processing apparatus for evaluating ride comfortability, specifically, it may include:

a data collection module, configured to obtain a driving action to be evaluated, and determine environmental information and/or vehicle driving parameters corresponding to the driving action to be evaluated;

an identification module, configured to input the environmental information and/or vehicle driving parameters corresponding to the driving action to be evaluated into the evaluation model constructed by the method according to any of the preceding methods, and outputting the ride comfortability corresponding to the driving action to be evaluated.

In an alternative embodiment, the evaluation information includes one or more of the following information: feeling of pushing a back, centrifugal feeling, bumpy feeling, forward feeling, frustration feeling and swaying feeling.

In an alternative embodiment, the environmental information includes one or more of the following information: weather information, road condition information and road surface status information; and/or, the vehicle driving parameters include one or more of the following information: vehicle model, driving speed, vehicle acceleration, rate of acceleration change, throttle output, brake output, turning angle, front and rear tilting angle, left and right swinging angle.

A person skilled in the art can clearly understand that for the convenience and brevity of the description, the specific working process of the system described above and the corresponding beneficial effects can refer to the corresponding processes in the foregoing method embodiments, and details are not described herein again.

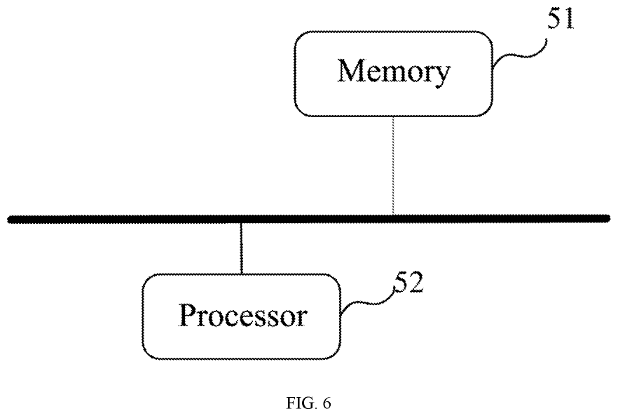

FIG. 6 is an another hardware schematic diagram of a data processing apparatus for evaluating ride comfortability according to the present disclosure. As shown in FIG. 6, the terminal includes a processor 52 and a computer program stored on a memory 51 and operable on the processor 52, the processor 52 performs the method of the above fifth embodiment when executing the computer program.

The present disclosure also provides a readable storage medium, comprising a program, when executed on a terminal, causing the terminal to perform the method of any of the above embodiments.

One of ordinary skill in the art can understand that all or part of the steps of implementing the foregoing method embodiments can be completed by hardware related to the program instructions. The aforementioned program can be stored in a computer readable storage medium. When the program is executed, the steps including the above method embodiments is executed; the foregoing storage medium includes: various media that can store program codes, such as a ROM, a RAM, a magnetic disk, or an optical disk etc.

Finally, it should be noted that the above embodiments are only used to illustrate the technical solution of the present disclosure, and are not limited thereto; although the present disclosure has been described in detail with reference to the foregoing embodiments, those skilled in the art should understand that the technical solutions described in the foregoing embodiments may be modified or equivalently substituted for some or all of the technical features. However, these modifications or substitutions do not deviate from the scope of the technical solutions of the embodiments of the present disclosure.

What is claimed is:

1. A data processing method for evaluating ride comfortability, comprising:
receiving evaluation data input by a user through a data collection port, the evaluation data comprising evaluation information of the user for each driving action of a vehicle on which the user rides;
determining environmental information and/or vehicle driving parameters when the vehicle executes each driving action; and
according to the evaluation information corresponding to each driving action of the vehicle, as well as the environmental information and/or vehicle driving parameters, training a preset deep learning algorithm model, to obtain an evaluation model for outputting ride comfortability.

2. The data processing method according to claim 1, wherein, the evaluation information comprises one or more of the following information:
feeling of pushing a back, centrifugal feeling, bumpy feeling, forward feeling, frustration feeling and swaying feeling.

3. The data processing method according to claim 1, wherein, the determining environmental information and/or vehicle driving parameters when the vehicle executes each driving action, comprises:
determining an execution location and an execution time when the vehicle executes each driving action;
determining the environmental information and/or vehicle driving parameters according to the execution location and the execution time.

4. The data processing method according to claim 1, wherein, the environmental information comprises one or more of the following information:
weather information, road condition information and road surface status information;
and/or, the vehicle driving parameters comprise one or more of the following information:
vehicle model, driving speed, vehicle acceleration, rate of acceleration change, throttle output, brake output, turning angle, front and rear tilting angle, left and right swinging angle.

5. A data processing apparatus for evaluating ride comfortability, comprising: a memory, a processor coupled to the memory, and a computer program stored on the memory and executable on the processor, wherein,
the processor performs to:
receive evaluation data input by a user through a data collection port, the evaluation data comprising evaluation information of the user for each driving action of a vehicle on which the user rides;
determine environmental information and/or vehicle driving parameters when the vehicle executes each driving action; and
according to the evaluation information corresponding to each driving action of the vehicle, as well as the environmental information and/or vehicle driving parameters, train a preset deep learning algorithm model, to obtain an evaluation model for outputting ride comfortability.

6. The data processing apparatus according to claim 5, wherein, the evaluation information comprises one or more of the following information:
feeling of pushing a back, centrifugal feeling, bumpy feeling, forward feeling, frustration feeling and swaying feeling.

7. The data processing apparatus according to claim 5, wherein, when the processor performs to determine environmental information and/or vehicle driving parameters when the vehicle executes each driving action, the processor specifically performs to:
determine an execution location and an execution time when the vehicle executes each driving action;
determine the environmental information and/or vehicle driving parameters according to the execution location and the execution time.

8. The data processing apparatus according to claim 5, wherein, the environmental information comprises one or more of the following information:
weather information, road condition information and road surface status information;
and/or, the vehicle driving parameters comprise one or more of the following information:
vehicle model, driving speed, vehicle acceleration, rate of acceleration change, throttle output, brake output, turning angle, front and rear tilting angle, left and right swinging angle.

9. A data processing apparatus for evaluating ride comfortability, comprising: a memory, a processor coupled to the memory, and a computer program stored on the memory and executable on the processor, wherein,
the processor performs to:
obtain a driving action to be evaluated, and determine environmental information and/or vehicle driving parameters corresponding to the driving action to be evaluated; and
input the environmental information and/or vehicle driving parameters corresponding to the driving action to be evaluated into the evaluation model constructed by the method of claim 1, and output the ride comfortability corresponding to the driving action to be evaluated.

10. The data processing apparatus according to claim 9, wherein,
the evaluation information comprises one or more of the following information:
feeling of pushing a back, centrifugal feeling, bumpy feeling, forward feeling, frustration feeling and swaying feeling.

11. The data processing apparatus according to claim 9, wherein, the environmental information comprises one or more of the following information:
weather information, road condition information and road surface status information;
and/or, the vehicle driving parameters comprise one or more of the following information:
vehicle model, driving speed, vehicle acceleration, rate of acceleration change, throttle output, brake output, turning angle, front and rear tilting angle, left and right swinging angle.

12. A readable storage medium, comprising a program, when executed on a terminal, causing the terminal to perform the method of claim 1.
